(19) United States
(12) Patent Application Publication
(10) Pub. No.: US 2005/0155778 A1
(43) Pub. Date: Jul. 21, 2005

(54) Power tool having outer protection layer

(76) Inventors: Hideki Ishida, Hitachinaka-shi (JP); Masato Sakai, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/036,013

(22) Filed: Jan. 18, 2005

(30) Foreign Application Priority Data
Jan. 16, 2004 (JP) P2004-009914

(51) Int. Cl. B27C 3/08

(52) U.S. Cl. 173/217; 173/170

(57) ABSTRACT

A powered tool having a first housing half and a second housing half coupled thereto to provide a sleeve section and a handle section suspended therefrom. These housing halves are made from a resin. A protection layer made from a material softer than that of the housing is distributed over the sleeve section and a handle section. A network pattern is provided as a part of the protection layer at the sleeve section. The network pattern is distributed over a parting face between the first and second housing halves. Further, a continuous web like pattern is also provided as a part of the protection layer at each lateral side of the sleeve section and each lateral side of the handle section.

### BACKGROUND OF THE INVENTION

The present invention relates to an electrically driven power tool, and more particularly, to such a tool provided with an outer protection layer made from a soft or elastic material.

A conventional impact driver 101 as a conventional power tool is shown in FIG. 12. The power tool has a housing 102 including a generally cylindrical sleeve 103 and a handle 104. These sleeve 103 and the handle 104 are entirely made from a resin. Further, a protective resin layer 115 is formed over the base resin, i.e., over the housing 102 and is made from a material such as a soft elastomeric material softer than that of the base resin. The protective resin layer 115 is formed at the handle 104 in order to avoid slippage of a hand and a finger relative to the handle 104, and to enhance gripping feeling to improve operability and workability.

The protective resin layer 115 is also formed at the rear side and lateral sides of the sleeve 103. The protective resin layer 115a at the lateral side extends in a frontward/rearward direction of the impact driver 101 in order to avoid injury to the surface of the sleeve 103 when the impact driver 101 is placed on a ground and to avoid slippage of the impact driver when the latter is placed on a slanting surface.

Japanese laid open patent application publication No.2003-39345 discloses a housing constituted by two complementary halves. A protective elastomer layer is formed over the respective halves such that the elastomer layers formed at one half and at the remaining half are integrally connected together by providing a connecting region also made from the elastomer. As a result, the numbers of runner in a metal mold for forming the protection layer can be reduced to avoid waste of the elastomer material, thereby reducing a production cost.

Japanese laid open patent application publication No.2003-245865 discloses a power tool including a housing, and a hammer case made from an aluminum. The hammer case is fixed to the housing with a fixing screw. A cover surrounding an outer periphery of the fixing screw is disposed over the hammer case in order to avoid surface injury of the power tool and an opponent member.

If the housing 102 of the impact driver 101 shown in FIG. 12 is in abutment with an opponent building material B as shown in FIG. 13 in a particular working environment, the base resin constituting the housing 102 is in direct contact with the opponent building material B. Thus, the building material B and/or the housing 102 may be damaged. If the impact driver 101 is dropped onto the ground and the housing 102 directly strikes against the ground, the impact driver 101 may be broken because the base resin constituting the housing 102 does not provide a sufficient shock absorbing function.

In order to avoid these drawbacks, a protection layer may be formed over an entire surface of the sleeve 103. However, this leads to an increase in amount of the protective material to increase production cost.

Further, a demand has been made such that a label or a decorative plate is to be fixed to the housing 102 for an identification or a decoration purpose. To this effect, the label or plate should not be fixed onto the protection layer but must be directly fixed to the base resin 102, because the label or the plate may be easily peeled off from the protection layer if the latter is made from an elastomer material. To attain this fixing, the elastomer layer may be separated from each other to permit the surface of the base resin of the housing 102 to be exposed to the label or plate. Accordingly, the numbers of gates in the metal mold may be increased to increase the cost of the metal mold.

Moreover, the label and the plate will be an important factor for enhancing an external appearance or design of the impact driver. The plate made from an easily moldable resin does not provide sufficient impact resistance, and may be easily destroyed if such plate is directly formed over the base resin of the housing 102.

### SUMMARY OF THE INVENTION

It is therefore an object of the present invention to overcome the above-described problems and to provide an improved power tool at a low cost capable of avoiding mutual damage to the tool and an opponent building material even if the tool is in direct contact therewith during a work at a narrow working spot, and ensuring hand gripping without any slippage to enhance operability and workability.

This and other objects of the present invention will be attained by a power tool including a housing and a protection layer. The housing includes a sleeve section and a handle section integral with the sleeve section. The sleeve section defines an upper region opposite to the handle section. The protection layer is distributed over at least at the upper region and is made from a material having a hardness lower than that of the housing.

In another aspect of the invention, there is provided a power tool including a housing, a protection layer, a motor, a power transmission mechanism, an end tool holding portion, and a switch. The housing includes a sleeve section and a handle section integral with the sleeve section. The housing includes a first housing half made from a resin and including a first sleeve half and a first handle half, and a second housing half made from a resin and including a second sleeve half coupled to the first sleeve half and a second handle half coupled to the first handle half to provide the sleeve section and the handle section. The sleeve section has a front side and a rear side defining a frontward/rearward direction. The handle section is positioned at the rear side. The protection layer is distributed over the housing and is made from a material softer than that of the resin. The motor is disposed in the sleeve section. The power transmission mechanism is disposed in the sleeve section and is positioned in front of the motor for transmitting driving force of the motor. The end tool holding portion is positioned in front of and connected to the power transmission mechanism. The switch is held at the handle for selectively supplying an electric power to the motor. The protection layer includes a rear region at the handle section, a lower region at the handle section and continuous with the rear region, a front region at the handle section and continuous with the lower region, a front region at the sleeve section and continuous with the front region at the handle, the upper region at the sleeve section and continuous with the front region at the sleeve, and a rear region at the sleeve section and continuous with the upper region at the sleeve section.

In still another aspect of the invention, there is provided a power tool including a housing, a protection layer, a motor, a power transmission mechanism, an end tool holding portion, and a switch. The housing is made from a resin. The protection layer is distributed over the housing and is made from an elastomeric material. The protection layer includes a region having a corrugated contour. The motor is disposed in the housing. The power transmission mechanism is disposed in the housing for transmitting driving force of the motor. The end tool holding portion is connected to the power transmission mechanism. The switch is held at the housing for selectively supplying an electric power to the motor.

In still another aspect of the invention, there is provided a power tool including a housing, a motor, an impact mechanism, an end tool holding mechanism, a switch, and a cover member. The housing includes a sleeve section, and a handle section integral with the sleeve section. The sleeve section has a front side and a rear side for defining a frontward/rearward direction. The handle section is positioned at the rear side. The sleeve section includes a rear sleeve section made from a resin and a front sleeve section made from a metal. The motor is disposed in the rear sleeve section. The impact mechanism is disposed in the front sleeve section and positioned in front of the motor for converting a driving force of the motor into an intermittent impact force. The end tool holding mechanism is positioned in front of and connected to the impact mechanism and is supported by the front sleeve section. The switch is held at the housing for selectively supplying an electric power to the motor. The cover member is disposed over the front sleeve section and is made from a resin. The cover member has a generally conical shape whose diameter is gradually reduced toward its front end. The conical cover member has an outer side surface on which a rib-like protrusion is formed.

In still another aspect of the invention, there is provided a power tool including a housing, a protection layer, a motor, a power transmission mechanism, an end tool holding portion, a switch, and a separate label-like plate member. The housing is made from a resin. The protection layer is distributed over the housing. The motor is disposed in the housing. The power transmission mechanism is disposed in the housing for transmitting driving force of the motor. The end tool holding portion is connected to the power transmission mechanism. The switch is held at the housing for selectively supplying an electric power to the motor. The separate label-like plate member is adhesively fixed onto the protection layer. Preferably, the protection layer is made from an elastomeric material and is distributed over the housing for defining a protection-layered areas and a non layered exposed areas. The separate label-like plate member is adhesively fixed onto both the protection-layered area and the non layered exposed area.

### BRIEF DESCRIPTION OF THE DRAWINGS

In the drawings:

FIG. 1 is a vertical cross-sectional view showing an internal arrangement of an impact driver according to a first embodiment of the present invention;

FIG. 2 is a front view showing the impact driver according to the first embodiment;

FIG. 3 is a right side view of the impact driver according to the first embodiment;

FIG. 4 is a left side view of the impact driver according to the first embodiment;

FIG. 5 is a cross-sectional view taken along the line V-V of FIG. 4;

FIG. 6 is a partial right side view of the impact driver according to the first embodiment, and showing a state prior to attachment of a decorative plate onto a housing;

FIG. 7 is a perspective view showing a state in which the impact driver according to the first embodiment is held by both hands;

FIG. 8 is a perspective view showing a state in which the impact driver according to the first embodiment is held in a reversal direction;

FIG. 9 is a perspective view showing a state in which the impact driver according to the first embodiment is shooting onto a fastener on a workpiece;

FIG. 10 is a right side view of an impact driver according to a second embodiment of the present invention;

FIG. 11 is a partial right side view of the impact driver according to the second embodiment, and showing a state prior to attachment of a decorative plate onto a housing;

FIG. 12 is a right side view showing a conventional impact driver; and

FIG. 13 is a cross-sectional view taken along the line XIII-XIII of FIG. 12.

### DETAILED DESCRIPTION OF THE PREFERRED EMBODIMENTS

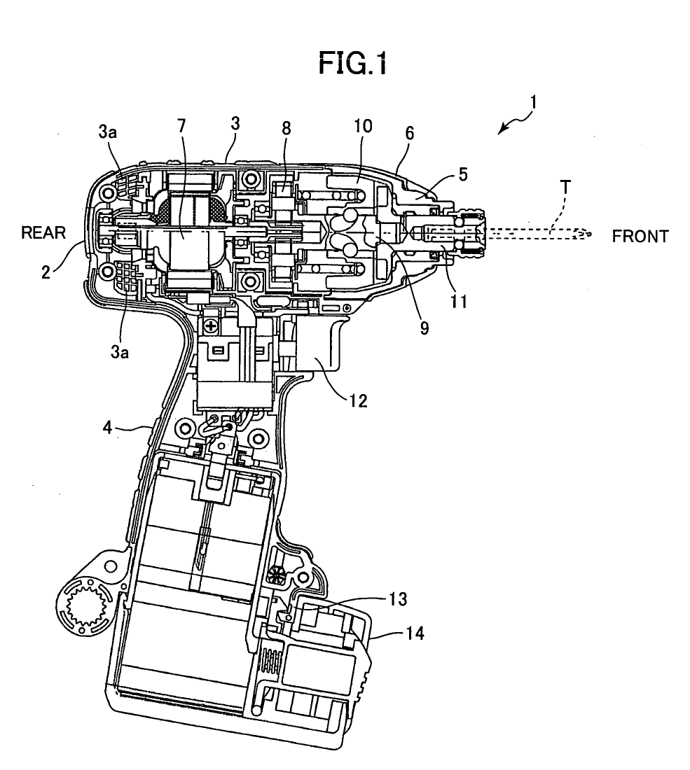

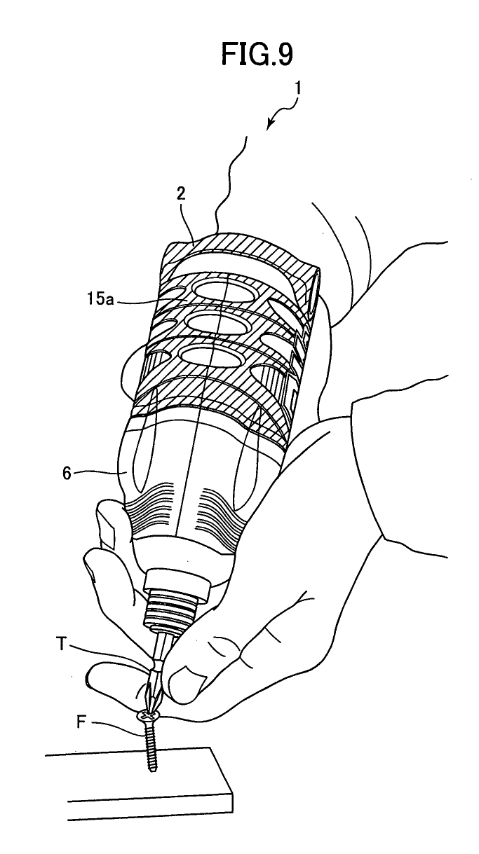

A power tool according to a first embodiment of the present invention will be described with reference to FIGS. 1 through 9. The first embodiment pertains to an impact driver 1.

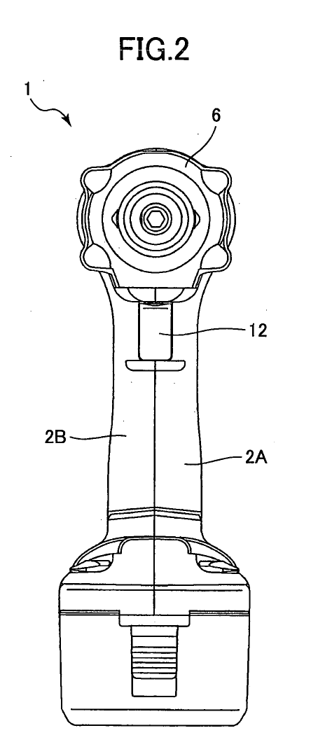

As shown in FIGS. 1 and 2, the impact driver 1 includes a housing 2 including two complementary housing halves 2A and 2B coupled together by screws (not shown) to constitute a rear sleeve 3 and a handle 4 suspended from the rear sleeve 3. The rear sleeve 3 has a generally circular cross-section. Air vent holes 3a are formed at a rear portion of the rear sleeve 3. The housing 2 is made from a resin such as nylon to constitutes a base resin and is produced by an injection molding.

A hammer case 5 is fixed to the front end of the rear sleeve 3 by screws (not shown) to serve as a front sleeve. The hammer case 5 is made from aluminum alloy. A protection cover 6 made from a soft material such as an elastomeric material is disposed over the hammer case 5. The protection cover 6 is adapted for avoiding mutual injury of the hammer case 5 and a building material B (FIG. 5), and avoiding slippage between the cover 6 and the user's hand when gripping. Further, the protection cover 6 can obviate burn injury against high temperature of the hammer case 5.

Diameters of the hammer case 5 and the protection cover 6 are gradually reduced toward their front ends, and an end tool T can extend through the front ends of the hammer case 5 and the protection cover 6. This diametrical reduction can facilitate operation of the impact driver 1 at a narrow working spot and can allow a user to easily observe the end tool T from a rear side of the housing 2.

A motor 7 serving as a drive source is disposed in the rear sleeve 3, and a planetary gear mechanism 8 serving as a power transmission section is connected to the motor 7. A spindle 9 is connected to the planetary gear mechanism 8 so that the spindle 9 performs decelerated rotation about its axis. A hammer 10 is disposed over the spindle 9 and is positioned within the hammer case 5. An anvil 11 serving as an end tool holding section protrudes from the front end of the hammer case 5. The hammer 10 is adapted for rotationally impact the anvil 11. The spindle 9 and the hammer 10 serve as an impact mechanism section. The motor 7, the spindle 9 and the anvil 11 are provided coaxially. A switch or a trigger 12 is provided at a front upper area of the handle 4. Further, a battery receiving section 13 is provided at an inner lower portion of the handle 4 to receive a battery 14.

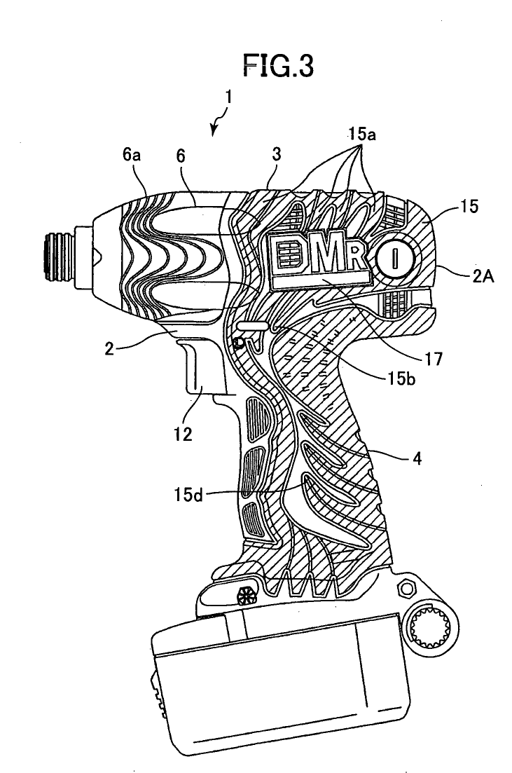

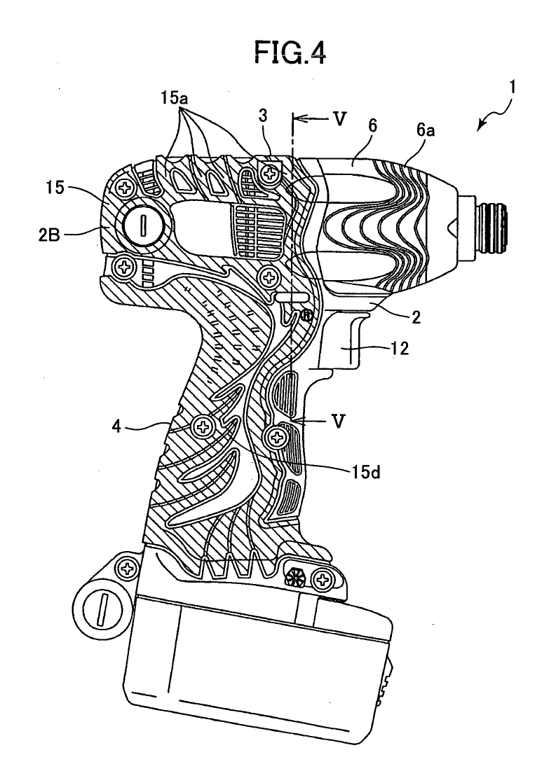

A protection layer 15 is formed over the base resin constituting the housing 2. The protection layer 15 is distributed over the almost entire outer surface of the housing 2 shown by hatching in FIGS. 3 and 4. The protection layer 15 is formed by injection molding. That is, the housing halves 2A, 2B are set in a metal mold, and a resin such as an elastomeric resin is injected into the metal mold. The injected resin is thermally fused onto the outer surface of the housing halves 2A, 2B. The resultant protection layer 15 has a hardness lower than that of the base resin which is the material of the housing halves 2A, 2B.

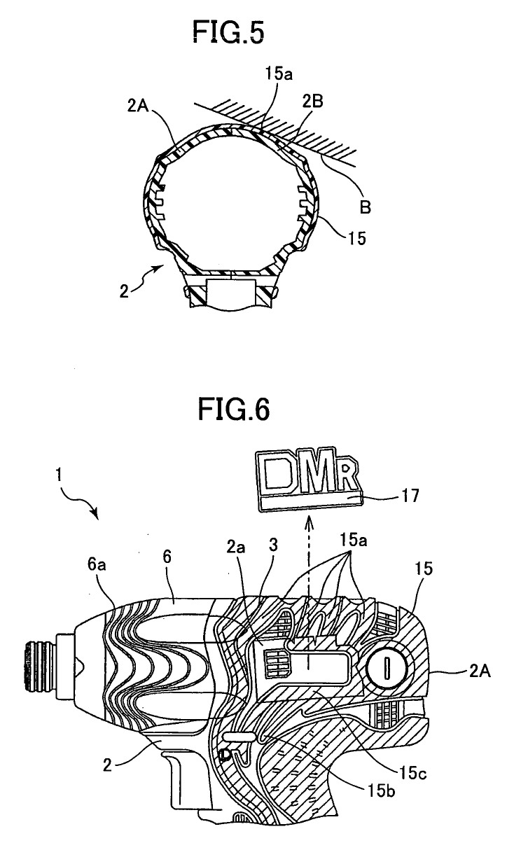

In FIG. 3, an area of the protection layer 15 occupies not less than 60% of the entire surface area of the housing half 2A. More specifically, as shown in FIG. 3, the protection layer 15 is provided at a rear lower region at the rear sleeve 3, a rear half region of the handle 4, a lower region of the handle 4, a front half region of the handle 4, a front region of the rear sleeve 3, an upper region 15a of the rear sleeve 3, a rear region of the rear sleeve 3 and a lower region 15b of the rear sleeve 3. The neighboring regions are connected to each other to provide a continuous protection layer 15. The above arrangement of the protection layer 15 is also symmetrically applied onto the remaining housing half 2B as shown in FIG. 4. The rear half region of the protection layer 15 on the housing halves 2A and 2B are connected together, and the upper region 15a of the protection layer 15 on the housing halves 2A and 2B are also connected together even at a parting face between the housing halves 2A and 2B. No protection layer 15 is formed on each central region on each lateral side of the rear sleeve 3. In other words, a non-protective region 2a (FIG. 6) is defined by the front region, the upper region 15a, the rear region and the lower region 15b of the protection layer 15.

Since the protection layer 15 is distributed almost entirely over the rear sleeve 3, mutual damage or injury between the housing 2 and the building material B can be avoided even if the housing 2 is in contact with the building material B during work as shown in FIG. 5. Further, since the protection layer 15 is continuously formed over the housing 2, that is, the protection layer 15 is unicursal, a single gate can only be formed in a metal mold for molding the protection layer 15 over the housing 2. Thus, a cost of molding can be reduced. Resin solidified in the gate becomes useless. Thus, if the numbers of the gate is reduced, economical consumption of the resin can result.

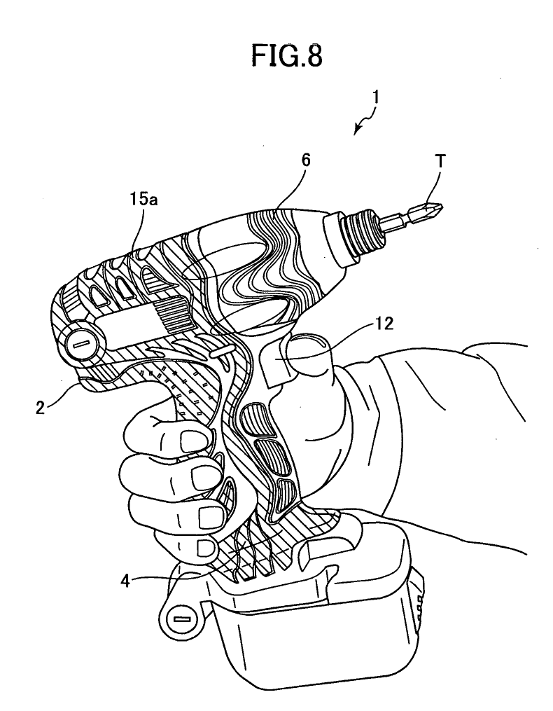

The protection layer 15 on the rear sleeve 3 will be described in more detail with reference to FIGS. 3 through 8. At an upper area of the right side of the rear sleeve 3 from an uppermost side thereof toward its lower side and occupying 30% area of the entire right side area of the rear sleeve 3, the protection layer 15 is in the form of a network pattern as best shown in FIG. 8. The network pattern has solid sections each having a width of about 7 mm in a frontward/rearward direction of the impact driver 1. Gaps each having a width of about 8 mm is defined between the neighboring solid sections. Thus, the solid section and the gap section are alternatingly formed with a cycle of about 15 mm to form the network pattern 15a. The same is true with respect to an upper area of the left side area of the rear sleeve 3. This network pattern also exists continuously at an uppermost parting face between the housing halves 2A and 2B. The distance of the gap is not limited to 8 mm but can be in a range of from 6 mm to 15 mm.

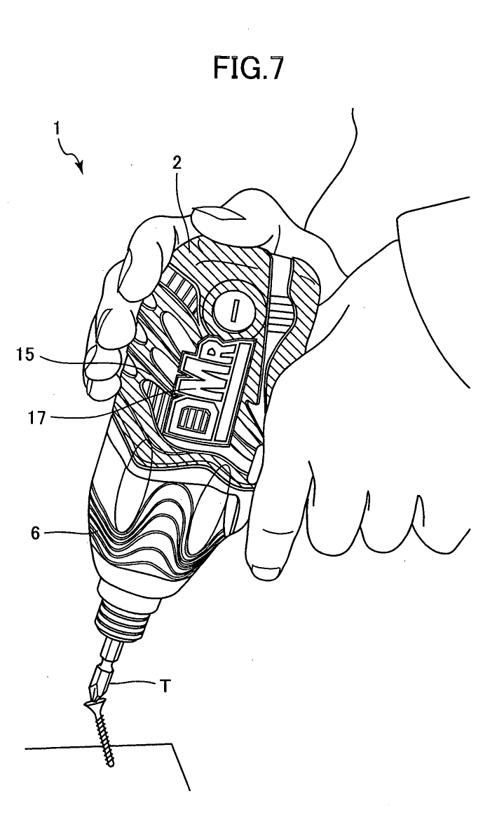

As shown in FIG. 7, when a user holds the rear sleeve 3 with his index finger, middle finger, annular finger, and fifth finger contacting with one another side by side and extending perpendicular to the frontward/rearward direction, each finger can be positioned on each gap. In other words, each finger is held between the neighboring solid sections of the network pattern to avoid slippage of the user's hand relative to the rear sleeve 3. Thus, the user can push the impact driver 1 frontwardly with a stabilized force. Further, with such holding manner, the fingers extend across the uppermost parting face between the housing halves 2A, 2B, thereby minimizing lateral vibration of the impact driver 1. Moreover, since the network pattern is continuously formed from one lateral side to the other lateral side of the rear sleeve 3 and is over the upper region thereof, the network pattern can prevent the base resin (constituting the housing 2) from being in direct contact with the building material B during driving work as shown in FIG. 5. Because the protection layer 15 is made from the material softer than the base resin 2, the direct contact does not damage to the building material B. Further, the protection layer 15 can function as a shock absorbing member when the impact driver 1 is accidentally dropped onto the ground. Furthermore, the network arrangement can save an amount of the elastomeric material as a material of the protection layer 15.

As shown in FIG. 6, the above-described non-protective region 2a is defined by the front region, the upper region 15a, the rear region and the lower region 15b of the protection layer 15. A plate or a label 17 for identification or decoration purpose is adhesively stuck onto both the non-protective region 2a and the protection layer 15. The stuck area of the protection layer 15 is designated as reference numeral 15c. The lower region 15b of the protection layer is the terminal end of the continuous protection layer 15. However, this lower region 15b can be supported to the remaining region of the protection layer 15 such as the upper region 15a by means of the plate 17 bridging between the base resin and the stuck area 15c. By this continuous or unicursal arrangement of the protection layer 15, the numbers of gate in a metal mold can be reduced to one. Moreover, the plate 17 can be sufficiently adhered to the base resin. Because the plate 17 is attached to the housing 2 through the region 15c of the protection layer 15, damage to the plate 17 can be reduced when the impact driver 1 is dropped onto the ground since the region 15c can absorb the shock. This is advantageous over a case where the plate is only directly attached onto the base resin.

The protection layer 15 on the handle 4 will be described in more detail with reference to FIGS. 3, 4 and 8. As described above, the protection layer 15 starts from the rear lower region of the rear sleeve 3 and ends at the lower region 15b at the rear sleeve 4 through a rear half region 15d at the handle 4, the lower region at the handle 4, and the front half region at the handle 4. A front edge of the rear half region 15d at the handle 4 is configured into a corrugated or wavy shape having an amplitude ranging from 10 to 35 mm. The corrugation contains from 3 to 4 apexes, and neighboring apexes are spaced away from each other by from 15 to 25 mm. Thus, user's fingers can be positioned on the non-protection layer areas, i.e., each finger can be positioned between neighboring waves of the protection layer 15. For a spiderman working at a high place, only a narrow foothold is provided. Therefore, the spiderman must hold the impact driver reversely in the frontward/rearward direction as shown in FIG. 8, so that his hand extends over an aerial non-foothold region in order to fasten a bolt by pulling the trigger 12 with a thumb. In order to achieve this unstable fastening work, the corrugated region 15d of the protection layer 15 is quite effective for ensuring hand gripping without any slippage.

Next, the protection cover 6 will be described in detail. A plurality of corrugated rib-like protrusions 6a integrally protrude from an outer surface of the protection cover 6. At each lateral side of the protection cover 6, the protruding length ranges from about 0.5 to 1 mm. With this arrangement, if the end tool T is to be aligned with the fastener F such as a screw, one hand grips the handle 4 whereas the other hand grips the protection cover 6. In this case, the finger can latch with the protrusions 6a, so that the gripping performance to the protection cover 6 can be improved.

Since the protection cover 6 covering the hammer case 5 is made from the elastomeric material and the housing 2 is covered with the elastomeric protection layer 15, almost entire outer surfaces of the outer frame constituted by the housing 2 and the hammer case 5 is protected by the soft elastomeric material, thereby enhancing protection ability to the outer frame.

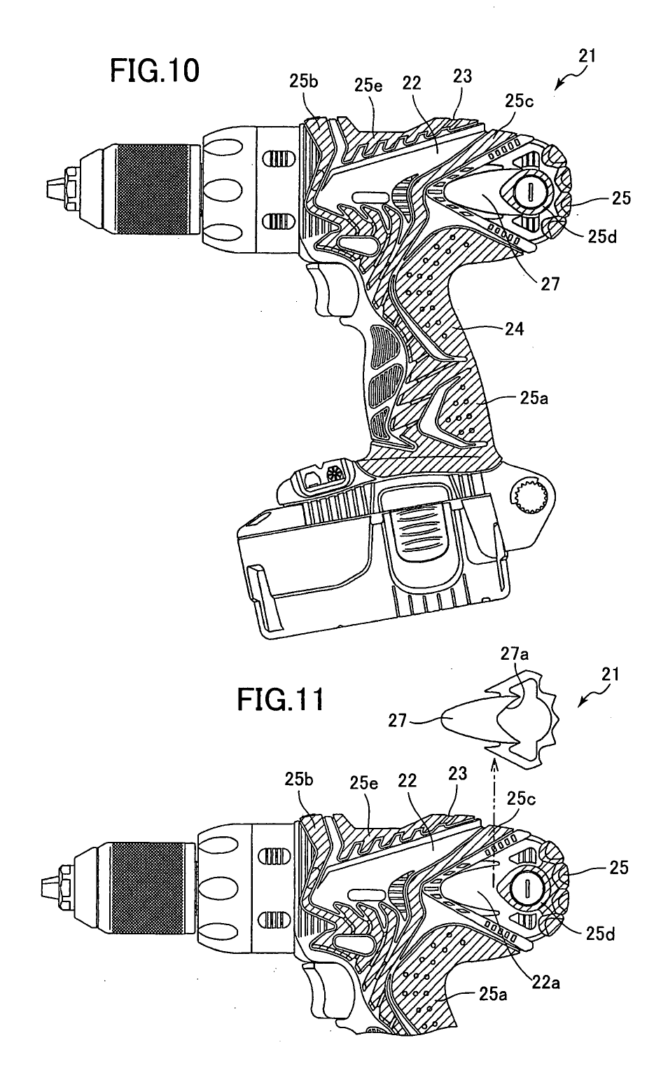

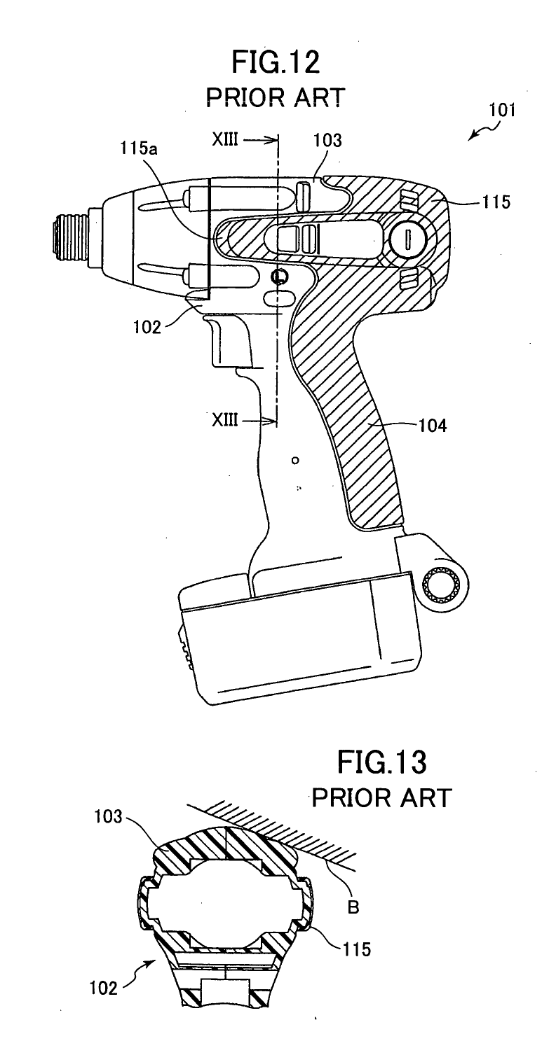

FIGS. 10 and 11 shows a driver drill 21 according to a second embodiment of the present invention. Similar to the first embodiment, a protection layer 25 is distributed over a rear sleeve 23 and a handle 24 of a housing 22 made from a nylon resin. The protection layer 25 includes a rear region 25a at the handle 24, a lower region at the handle 24, a front region at the handle 24, a front web like region 25b and a rear web like region 25c at the sleeve 23, and a rear region 25d at the rear side of the sleeve 23. The protection layer 25 also includes an upper region 25e at an upper portion of the sleeve 23. The web like regions 25b and 25c are branched from the protection layer region at the handle 24. A non-protection region 22a is defined between the rear web like region 25c and the rear region 25d. Since the front and rear web like regions 25b and 25c are connected to the protection region at the handle 24, these regions can be formed integrally by a metal mold having a single gate. Thus, a cost of the metal mold can be reduced, and economical consumption of the elastomeric resin can result.

A decorative plate or label 27 formed with an opening 27a is attached to the sleeve 23. More specifically, a major part of the decorative plate 27 is attached onto the non-protection region 22a, and a remaining part of the plate 27 is attached onto a stuck area 25d positioned beside the opening 27a. A front end of the rear region 25d is a distal end of the protection layer 25 within a meaning of the unicursal configuration. The distal end can be held by the decorative plate 27 and the neighboring region 25d contiguous with the distal end. In other words, since the plate 27 bridges over the non-protection area 22a and the protection area 25d, the protection layer 25 can be stably held on the base resin. In this connection, the advantage similar to that in the first embodiment can be obtained in terms of shock absorbing function for the plate 27.

While the invention has been described in detail with reference to specific embodiments thereof, it would be apparent to those skilled in the art that various changes and modifications may be made therein without departing from the spirit and scope of the invention. For example, the present invention is also available for other type of power tools such as a circular saw in addition to the impact driver 1 and the driver drill 21.

1. A power tool comprising:
a housing including a sleeve section and a handle section integral with the sleeve section, the sleeve section defining an upper region opposite to the handle section; and
a protection layer distributed over at least at the upper region and made from a material having a hardness lower than that of the housing.

2. The power tool as claimed in claim 1, wherein the sleeve section has a generally hollow cylindrical shape.

3. The power tool as claimed in claim 1, wherein the housing is made from a resin and the material of the protection layer is an elastomeric material.

4. The power tool as claimed in claim 1, wherein the sleeve section has a front side and a rear side defining a frontward/rearward direction, the handle being positioned at the rear side, and
wherein the protection layer formed at least at the upper region is in a form of a network pattern providing an alternating solid section and space section arrayed in the frontward/rearward direction.

5. The power tool as claimed in claim 4, wherein each space section has a width ranging from 6 mm to 15 mm in the frontward/rearward direction.

6. The power tool as claimed in claim 1, wherein the housing comprises a first housing half including a first sleeve half and a first handle half, and a second housing half including a second sleeve half coupled to the first sleeve half and a second handle half coupled to the first handle half, a parting face being defined between the first housing half and the second housing half; and
wherein the protection layer is distributed over the parting face.

7. The power tool as claimed in claim 1, wherein the sleeve section has a front side and a rear side defining a frontward/rearward direction, the handle section being positioned at the rear side; the power tool further comprising:
a motor disposed in the sleeve section;
a power transmission mechanism disposed in the sleeve section and positioned in front of the motor for transmitting driving force of the motor;
an end tool holding portion positioned in front of and connected to the power transmission mechanism; and
a switch held at the housing for selectively supplying an electric power to the motor.

8. The power tool as claimed in claim 1, wherein the housing includes a resin part comprising a first housing half provided with a first sleeve half and a first handle half, and a second housing half provided with a second sleeve half coupled to the first sleeve half and a second handle half coupled to the first handle half to provide the sleeve section and the handle section; and
wherein the sleeve section has a front side and a rear side defining a frontward/rearward direction, the handle section being positioned at the rear side; and
wherein the protection layer comprises:
a rear region at the handle section;
a lower region at the handle section and continuous with the rear region;
a front region at the handle section and continuous with the lower region;
a front region at the sleeve section and continuous with the front region at the handle;
the upper region at the sleeve section and continuous with the front region at the sleeve; and
a rear region at the sleeve section and continuous with the upper region at the sleeve section.

9. The power tool as claimed in claim 1, wherein the housing is made from a resin, and
wherein the protection layer is made from an elastomeric material, and the protection layer has a region having a corrugated contour.

10. The power tool as claimed in claim 1, wherein the sleeve section has a front side and a rear side defining a frontward/rearward direction, the handle section being positioned at the rear side;
wherein the sleeve section comprises a rear sleeve section made from a resin and a front sleeve section made from a metal;
and the power tool further comprising:
a motor disposed in the rear sleeve section;
a power transmission mechanism disposed in the front sleeve section and positioned in front of the motor for transmitting driving force of the motor;
an end tool holding mechanism supported by the front sleeve section and positioned in front of and connected to the power transmission mechanism; and
a switch held at the housing for selectively supplying an electric power to the motor; and
a cover member disposed over the front sleeve section and made from a resin, the cover member having a generally conical shape whose diameter is gradually reduced toward its front end, the cover member having an outer side surface on which a rib-like protrusion is formed.

11. The power tool as claimed in claim 1, further comprising a separate label-like plate member adhesively fixed onto the protection layer.

12. The power tool as claimed in claim 11, wherein the protection layer is made from an elastomeric material, and
wherein the protection layer is distributed over the housing for defining a protection-layered areas and a non layered exposed areas; and
the power tool further comprising a separate label-like plate member adhesively fixed onto both the protection-layered area and the non layered exposed area.

13. A power tool comprising:
a housing including a sleeve section and a handle section integral with the sleeve section, the housing comprising a first housing half made from a resin and including a first sleeve half and a first handle half, and a second housing half made from a resin and including a second sleeve half coupled to the first sleeve half and a second handle half coupled to the first handle half to provide the sleeve section and the handle section, the sleeve section having a front side and a rear side defining a frontward/rearward direction, the handle section being positioned at the rear side;
a protection layer distributed over the housing and made from a material softer than that of the resin;
a motor disposed in the sleeve section;
a power transmission mechanism disposed in the sleeve section and positioned in front of the motor for transmitting driving force of the motor;
an end tool holding portion positioned in front of and connected to the power transmission mechanism; and
a switch held at the handle for selectively supplying an electric power to the motor; and
wherein the protection layer comprises:
a rear region at the handle section;
a lower region at the handle section and continuous with the rear region;
a front region at the handle section and continuous with the lower region;
a front region at the sleeve section and continuous with the front region at the handle;
the upper region at the sleeve section and continuous with the front region at the sleeve; and
a rear region at the sleeve section and continuous with the upper region at the sleeve section.

14. A power tool comprising:
a housing made from a resin;
a protection layer distributed over the housing and made from an elastomeric material, the protection layer including a region having a corrugated contour;
a motor disposed in the housing;
a power transmission mechanism disposed in the housing for transmitting driving force of the motor;
an end tool holding portion connected to the power transmission mechanism; and
a switch held at the housing for selectively supplying an electric power to the motor.

15. A power tool comprising:
a housing including a sleeve section, and a handle section integral with the sleeve section;
wherein the sleeve section has a front side and a rear side for defining a frontward/rearward direction, the handle section being positioned at the rear side;
wherein the sleeve section comprises a rear sleeve section made from a resin and a front sleeve section made from a metal;
and the power tool further comprising:
a motor disposed in the rear sleeve section;
an impact mechanism disposed in the front sleeve section and positioned in front of the motor for converting a driving force of the motor into an intermittent impact force;
an end tool holding mechanism positioned in front of and connected to the impact mechanism and supported by the front sleeve section; and
a switch held at the housing for selectively supplying an electric power to the motor; and
a cover member disposed over the front sleeve section and made from a resin, the cover member having a generally conical shape whose diameter is gradually reduced toward its front end, the cover member having an outer side surface on which a rib-like protrusion is formed.

16. A power tool comprising:
a housing made from a resin;
a protection layer distributed over the housing;
a motor disposed in the housing;
a power transmission mechanism disposed in the housing for transmitting driving force of the motor;
an end tool holding portion connected to the power transmission mechanism;
a switch held at the housing for selectively supplying an electric power to the motor; and
a separate label-like plate member adhesively fixed onto the protection layer.

17. The power tool as claimed in claim 16, wherein the protection layer is made from an elastomeric material and distributed over the housing for defining a protection-layered areas and a non layered exposed areas, the separate label-like plate member adhesively fixed onto both the protection-layered area and the non layered exposed area.
